(19) United States
(12) Patent Application Publication
(10) Pub. No.: US 2009/0050716 A1
(43) Pub. Date: Feb. 26, 2009

(54) High-pressure spray gun

(75) Inventors: Juergen Binder, Leutenbach (DE); Vitali Fischer, Backnang (DE); Rolf Lindauer, Wiernsheim (DE); Joerg Schmid, Spiegelberg (DE)

Correspondence Address: Lipsitz & McAllister, LLC, 755 MAIN STREET, MONROE, CT, 06468, US

(73) Assignee: Alfred Kaercher GmbH & Co. KG, Winnenden (DE)

(21) Appl. No.: 12/231,334

(22) Filed: Aug. 28, 2008

Related U.S. Application Data
(63) Continuation of application No. PCT/EP2007/001843, filed on Mar. 3, 2007.

(30) Foreign Application Priority Data
Mar. 22, 2006 (DE) 10 2006 013 005.7

(51) Int. Cl. B05B 7/02

(52) U.S. Cl. 239/526

(57) ABSTRACT

The invention relates to a high-pressure spray gun for a high-pressure cleaning appliance, comprising a housing having arranged therein a valve with an inlet channel and an outlet channel and a closing body, which is adapted to rest in a sealing manner on a sealing surface arranged between the inlet channel and the outlet channel, and which interacts with a hand lever, an insert nipple being insertable into the inlet channel and fixable in an axially immovable manner for connection of a liquid supply line. To further develop the high-pressure spray gun in such a way that a liquid supply line can be connected to and separated from the valve in a simple way, it is proposed in accordance with the invention that the high-pressure spray gun comprise an immovable securing clip with two securing parts, which are insertable into diametrically opposed lateral openings of the inlet channel in order to engage behind the insert nipple, and which are spreadable apart in a spring-elastic manner by an actuating element which is displaceably arranged in the housing.

This application is a continuation of international application number PCT/EP2007/001843 filed on Mar. 3, 2007.

The present disclosure relates to the subject matter disclosed in international application number PCT/EP2007/001843 of Mar. 3, 2007 and German application number 10 2006 013 005.7 of Mar. 22, 2006, which are incorporated herein by reference in their entirety and for all purposes.

### BACKGROUND OF THE INVENTION

The invention relates to a high-pressure spray gun for a high-pressure cleaning appliance, comprising a housing having arranged therein a valve with an inlet channel and an outlet channel and a closing body, which is adapted to rest in a sealing manner on a sealing surface arranged between the inlet channel and the outlet channel, and which interacts with a hand lever, an insert nipple being insertable into the inlet channel and fixable in an axially immovable manner for connection of a liquid supply line.

Such high-pressure spray guns are used for high-pressure cleaning appliances and make it possible to aim the cleaning liquid which is pressurized by the high-pressure cleaning appliance at a surface that is to be cleaned. The amount of cleaning liquid discharged can be regulated by the high-pressure spray gun. In particular, the flow of the cleaning liquid can be interrupted by the high-pressure spray gun. The cleaning liquid is pressurized by the high-pressure cleaning appliance and delivered to the high-pressure spray gun through a liquid supply line.

The liquid supply line is connected to the high-pressure spray gun with the aid of an insert nipple, which can be inserted into the inlet channel of the valve of the high-pressure spray gun and fixed in an axially immovable manner. Such high-pressure spray guns are known, for example, from European patent application EP 0 901 834 A2. In the design described therein, the insert nipple is fixed by a fastening nut. This calls for a constructionally elaborate design.

A high-pressure spray gun is known from the patent DE 10 2004 006 592 B3. Herein a high-pressure hose, by means of which the high-pressure spray gun is connected to the high-pressure cleaning appliance, can be fixed with the aid of a U-shaped clip. However, the high-pressure hose is not connected directly to the valve, but rather an additional liquid channel, which is made of plastic and is surrounded by a metal sleeve, is provided between the valve and the high-pressure hose.

### SUMMARY OF THE INVENTION

The object of the present invention is to further develop a high-pressure spray gun of the kind mentioned at the outset so that a liquid supply line can be connected to and separated from the valve in a simple way.

This object is accomplished, in accordance with the invention, in a high-pressure spray gun of the generic kind, in that the high-pressure spray gun comprises an immovable securing clip with two securing parts, which are insertable into diametrically opposed lateral openings of the inlet channel in order to engage behind the insert nipple, and which are spreadable apart in a spring-elastic manner by an actuating element which is displaceably arranged in the housing.

In accordance with the invention, a securing clip with two securing parts is used to axially fix the insert nipple in the inlet channel. The securing parts can engage behind a circumferential collar of the insert nipple, so that the insert nipple can be axially fixed in the inlet channel in a simple way. To connect a high-pressure hose to the valve and separate the high-pressure hose from the valve in a simple way, it is provided, in accordance with invention, that the two securing parts are transferable with the aid of an actuating element arranged displaceably in the housing from their lock position in which they engage behind the circumferential collar of an insert nipple inserted into the inlet channel to a release position in which they release the insert nipple. To do so, it is merely necessary to displace the actuating element, whereas the securing clip is held immovably in the housing. By displacing the actuating element, the two securing parts are spread apart and thereby move into their release position in which they are arranged at a spacing from the insert nipple. If the actuating element is released again by the user, then the spring-elastically spread-apart securing parts automatically return to their lock position. A distinguishing feature of the high-pressure spray gun according to the invention is, therefore, its particularly easy handling when connecting a liquid supply line to the valve.

It is advantageous for the actuating element to be displaceably held in a guide, for example, a shaft of the housing. For example, the housing may be of two-part construction and made up of two housing shells with inwardly lying ribs which, when the two housing shells are joined, form a shaft constituting a guide for the actuating element.

In a particularly preferred embodiment, the actuating element forms a wedge which is insertable between the two securing parts. In such a configuration, the actuating element has two wedge surfaces which are aligned at an incline to each other and on which the securing parts can rest. By displacing the actuating element, the two wedge surfaces can be inserted between the securing parts, and the securing parts can thereby be spread apart.

The actuating element is preferably designed as a pushbutton which blends into the outer contour of the housing. This makes for an attractive design of the high-pressure spray gun with avoidance of an actuating element protruding outwardly from the housing. Rather, the actuating element blends into the contour of the housing, and the danger of damage being caused is thereby reduced.

The pushbutton may be arranged, for example, in the area of transition between a gripping portion and an outlet area of the housing. The handling of the actuating element designed as pushbutton is thereby simplified as the pushbutton can be arranged at a place which can be easily gripped by the user when taking hold of the high-pressure spray gun.

In a preferred embodiment, the assembly of the high-pressure spray gun is simplified by the actuating element being held on the securing clip. This makes it possible to assemble the valve including the securing clip and the associated actuating element so as to then insert it into a housing shell. The actuating element is preferably held undetachably on the securing clip.

It may, for example, be provided that the actuating element has a clamp portion which is clamped between the securing parts. In such a configuration, the two securing parts exert a spring-elastic clamping force on the clamp portion, and the actuating element is, therefore, held in a constructionally simple manner on the securing clip.

The actuating element may, for example, be designed as a one-piece shaped part made of plastic. It is particularly advantageous for the actuating element to have a roughened actuating surface, which is preferably fluted or ribbed and forms part of the outer contour of the housing.

So far, no details of the design of the securing clip have been given. It is expedient for the securing clip to comprise a spring element which joins the ends of the securing parts that face away from the actuating element to each other. A spring force may be exerted on the securing parts by the spring element, so that these automatically assume their lock position and are moved into their release position by the action of an actuating force counteracting the spring force.

In a preferred embodiment of the high-pressure spray gun according to the invention, the spring element is of U-shaped configuration with two legs which are joined to each other by a crosspiece. It may be provided that the legs of the spring element are each aligned collinearly in relation to a securing part. The securing parts preferably extend perpendicularly to the longitudinal axis of the inlet channel of the valve.

In a preferred embodiment, the two legs of the U-shaped spring element are aligned parallel to the longitudinal axis of the inlet channel. This makes for a particularly compact design of the securing clip. In particular, it may be provided that the securing parts are each aligned perpendicularly to the legs of the spring element. Hence the spring element extends in the longitudinal direction of the insert nipple, which is inserted into the inlet channel.

It is expedient for the spring element to be integrally joined to the securing parts. It may, for example, be provided that the spring element and the securing parts are jointly formed as a one-piece wire bracket. The securing parts can then be spread apart by the exertion of a relatively small actuating force and nevertheless transfer reliably into their lock position when the actuating element is released.

The following description of a preferred embodiment of the invention serves in conjunction with the drawings for a more detailed explanation.

### BRIEF DESCRIPTION OF THE DRAWINGS

FIG. 1 shows a schematic sectional view of a high-pressure spray gun according to the invention;

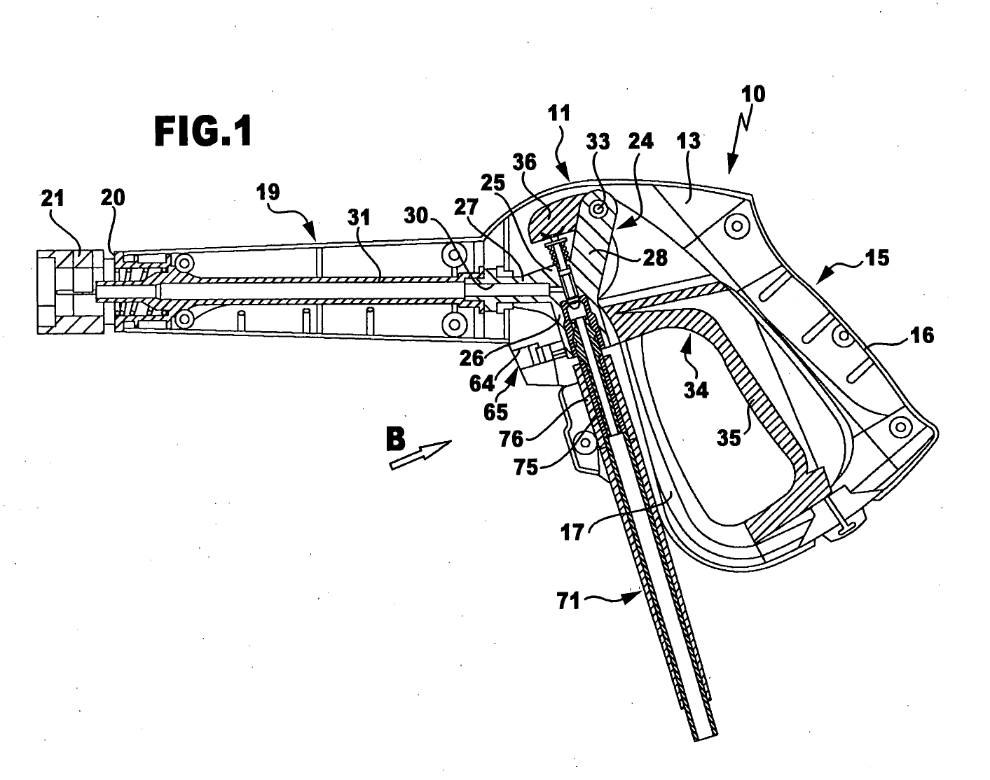

FIG. 2 shows an enlarged sectional view of the valve of the high-pressure spray gun from FIG. 1 with a fitting of a liquid supply line connected thereto;

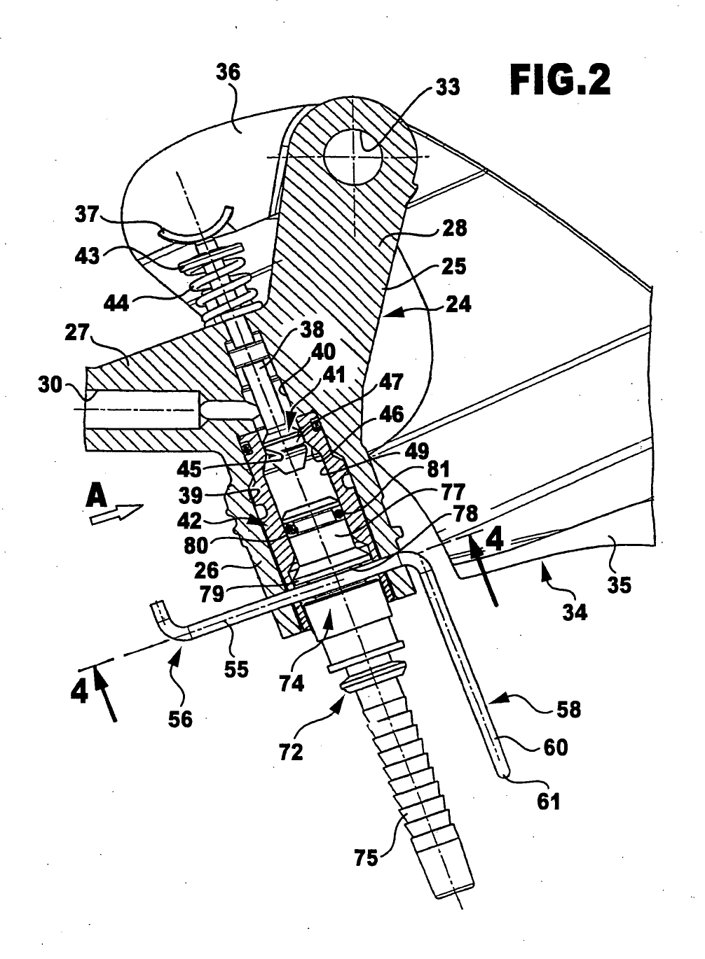

FIG. 3 shows a side view of the valve in the direction of arrow A from FIG. 2;

FIG. 4 shows a sectional view taken along line 4-4 in FIG. 2;

FIG. 5 shows a perspective representation of the valve of the high-pressure spray gun from FIG. 1; and

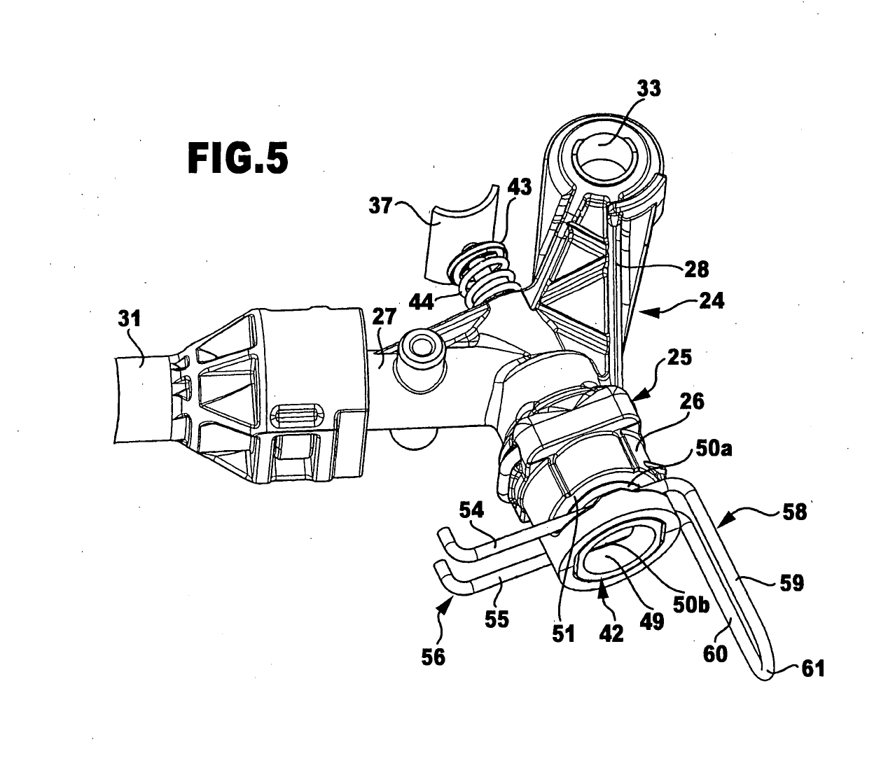

FIG. 6 shows a view of the high-pressure spray gun in the direction of arrow B from FIG. 1.

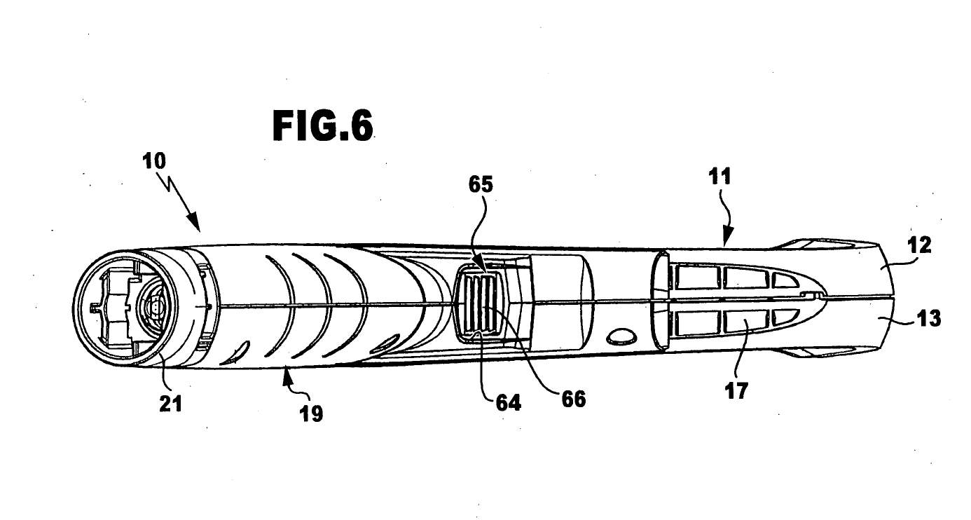

### DETAILED DESCRIPTION OF THE INVENTION

The drawings show schematically a high-pressure spray gun generally designated by reference numeral 10 with a housing 11 made of plastic, which is formed by two half-shells 12, 13. The housing 11 comprises a gripping portion 15 with a handle 16 and a protective bracket 17. The housing 11 also forms an outlet area 19 with an outlet 20, to which a bayonet coupling 21 is fixed.

The housing 11 accommodates a valve 24 with a valve housing 25, which is essentially Y-shaped and has a central connector 26, from which a first leg 27 and a second leg 28, facing away from each other, project. The first leg 27 forms an outlet channel 30, to the free end of which there is connected a pipe section 31, which extends as far as the outlet 20, and to which a spray lance. can be connected by means of the bayonet coupling 21.

The free end of the second leg 28 forms a rotary bearing 33, on which a hand lever 34 is pivotally mounted. The hand lever 34 comprises a first lever arm 35 and a second lever arm 36. Starting from the rotary bearing 33, the first lever arm 35 extends into the area between the handle 16 and the protective bracket 17. It is, therefore, easy for the user to grip the first lever arm 35 with his hand.

The second lever arm 36 is considerably shorter than the first lever arm 35. A valve tappet 38, which enters into a through-bore 40 of the valve housing 25 and carries at its end facing away from the second lever arm 36 a closing body 41, rests on the second lever arm 36 via a metallic pressure plate 37 clipped into the second lever arm 36. A supporting ring 43 is fixed to the valve tappet 38 in an end area which projects beyond the valve housing 25. There is clamped between the supporting ring 43 and the valve housing 25 a pressure spring 44 which acts upon the valve tappet 38 and the closing body 41 with a spring force that faces the second lever arm 36.

The through-bore 40 opens into a chamber 39 of the valve housing 25, which accommodates an insert 42. While the valve housing 25 is made from an inexpensive plastic material, for example, from a polyamide or polypropylene material, the insert 42 is made of metal, preferably of brass. At the level of the closing body 41, it forms a conical shoulder 46 which is adjoined in flow direction by a sealing channel with a sealing surface 45. Under the action of the pressure spring 44, the closing body 41, which is surrounded by a sealing ring 47, comes to rest in a sealing manner on the sealing surface 45. By pivoting the hand lever 34, the closing body 41 can be lifted off the sealing surface 45 and thereby moved from its closed position to its open position.

Upstream from the sealing surface 45, the insert 42 forms an inlet channel 49, and downstream from the sealing surface 45, the outlet channel 30 branches off from the through-bore 40.

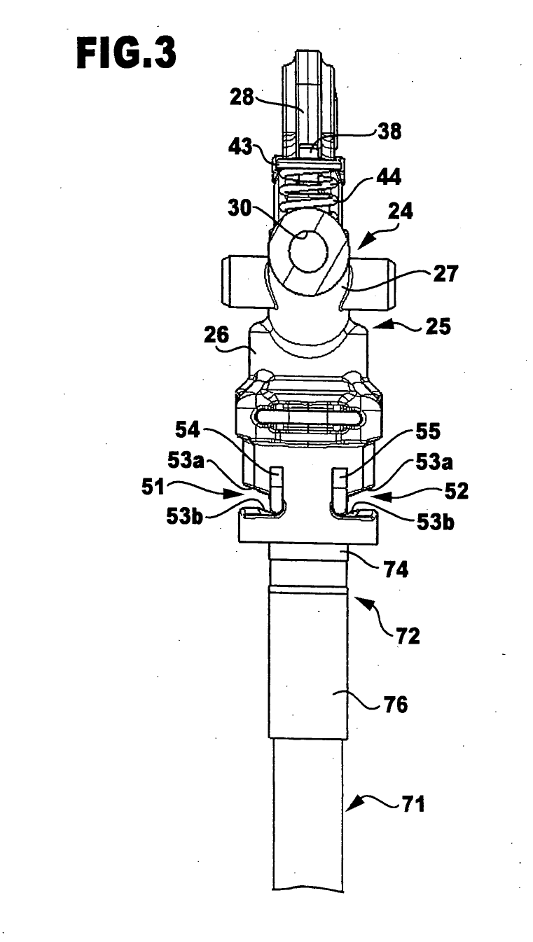

At the level of the inlet channel 49, the insert 42 has two diametrically opposed lateral openings in the form of two insert slots 50a, 50b, which each extend in circumferential direction over a section of the inlet channel 49 and are each aligned with a corresponding lateral opening in the valve housing 25 in the form of an insert slot 51 and 52, respectively. As will be apparent from FIG. 3, the insert slots 50a, 50b, 51, 52 each have an upstream wall portion 53a and a downstream wall portion 53b, which, at least in their radially inward area, are inclined at an angle to the radial direction, namely in flow direction.

A securing part 54 and 55, respectively, of a securing clip 56 passes transversely to the longitudinal axis of the inlet channel 49 through the insert slots 50a, 50b and 51, 52. The securing clip 56 is in the form of a one-piece wire bracket and comprises in addition to the securing parts 54 and 55 a U-shaped spring element 58 with a first leg 59 and a second leg 60, which are integrally joined to each other by a circular arc-shaped crosspiece 61, and which are each integrally joined to a securing part 54 and 55, respectively. The ends of the securing parts 54 and 55 facing away from the spring element 58 are bent through 90° in the direction of the first leg 27 of the valve housing 25.

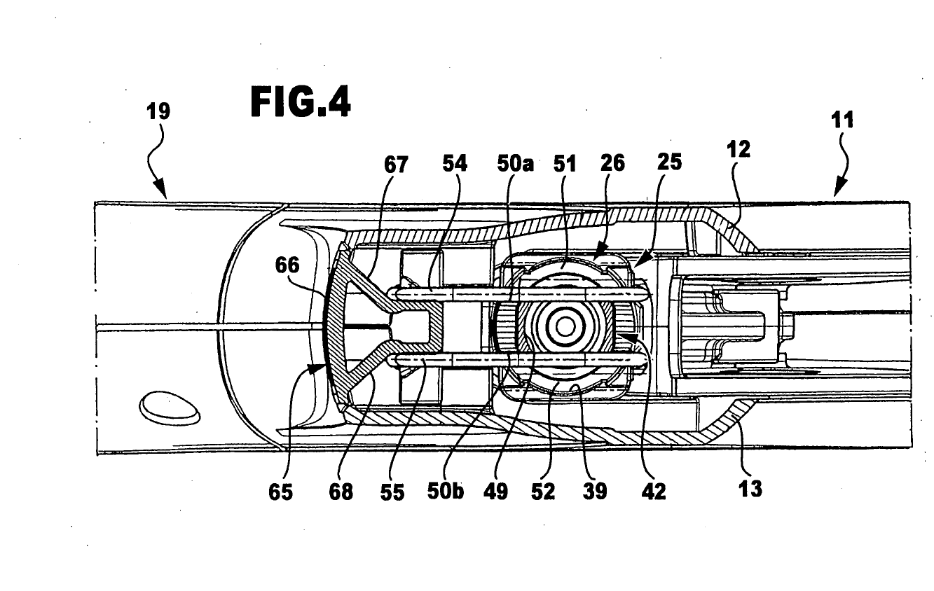

At the level of the inlet channel 49, the housing 11 forms a guide shaft 64 which accommodates in a displaceable manner an actuating element in the form of a pushbutton 65 made of plastic. The pushbutton 65 forms a fluted, convexly outwardly curved bearing surface 66 which blends into the outer contour of the housing 11. As will be apparent from FIG. 4, the pushbutton 65 has on the inner side facing away from the bearing surface 66 two wedge surfaces 67, 68 which are aligned at an incline to each other and are integrally joined to each other by a clamp portion 69 of U-shaped cross section. With the clamp portion 69, the pushbutton 65 projects between the two securing parts 54, 55, which clamp the clamp portion 69 between them by means of the spring force exerted by the spring element 58.

A liquid supply line in the form of a high-pressure hose 71 can be connected to the high-pressure spray gun 10. For this purpose, a connection fitting 72 is used, which has an insert nipple 74 which is insertable into the inlet channel 49, and a press-in nipple 75 which enters into the free end of the high-pressure hose 71 and is pressed to the high-pressure hose 71 with the aid of a press sleeve 76 embracing the high-pressure hose 71.

Inside the inlet channel 49, the insert nipple 74 has an annular circumferential groove 78 which is adjoined upstream by a circumferential collar 79. Upstream from the collar 79, the insert nipple 74 carries in an end area 77 of smaller diameter a further annular groove 80 which accommodates a sealing ring 81. The sealing ring 81 lies in a sealing manner against the wall of the inlet channel 49.

The insert nipple 74 inserted into the inlet channel 49 is fixed in axial direction by the securing clip 56. To this end, the securing parts 54, 55 engage behind the collar 79 and enter into the annular groove 78. If the high-pressure hose 71 is to be released from the high-pressure spray gun 10, it is only necessary to actuate the pushbutton 65, i.e., to push it into the guide shaft 64. The consequence of this is that the end areas of the securing parts 54 and 55 that face away from the spring element 58 slide along the wedge surfaces 67 and 68, respectively, and are thereby spread apart against the spring force exerted by the spring element 58. They can be spread apart by the pushbutton 65 to such an extent that they become disengaged from the insert nipple 74, so that it can be readily pulled out of the inlet channel 49 by the user and the high-pressure hose 71 can thereby be separated from the high-pressure spray gun 10. When the pushbutton 65 is released by the user, it is moved by the securing parts 54, 55 to the free end of the guide shaft 64 again as the securing parts 54, 55 are acted upon with an elastic restoring force by the spring element 58. If the high-pressure hose 71 is to be connected again, then the securing parts 54, 55 can be spread apart again by the pushbutton 65, so that the insert nipple 74 can be inserted in a simple manner into the inlet channel 49. Alternatively, the end area 77 of the insert nipple can be inserted between the securing parts 54, 55, and the insert nipple 74 then pressed in between the securing parts 54, 55, so that these can be moved by the insert nipple 74 into their release position. To enable insertion of the end area 77 between the securing parts 54, 55, the diameter of the end area is smaller than the spacing between the securing parts 54, 55. The insert nipple 74 can be inserted so far into the inlet channel 49 that the securing parts enter into the annular groove 78 and thereby fix the insert nipple in axial direction. A distinguishing feature of the high-pressure spray gun 10 according to the invention is, therefore, its very easy handling when connecting the high-pressure hose 71. When the high pressure hose 71 connected to the high-pressure spray gun 10 is acted upon by cleaning liquid under pressure, the insert nipple 74 and, by way of the insert nipple 74, also the securing clip 56 are then subjected to a tensile force in the direction opposite to the direction of flow of the cleaning liquid. Owing to the wall portions 53a of the insert slots 50a, 50b, 51, 52 being aligned at an incline to the radial direction, this has the consequence that the securing parts 54, 55 resting on the wall portions 53a are pressed together and thereby exert an increased holding force on the insert nipple 74.

1. High-pressure spray gun for a high-pressure cleaning appliance, comprising a housing having arranged therein a valve with an inlet channel and an outlet channel and a closing body, which is adapted to rest in a sealing manner on a sealing surface arranged between the inlet channel and the outlet channel, and which interacts with a hand lever, an insert nipple being insertable into the inlet channel and fixable in an axially immovable manner for connection of a liquid supply line, said high-pressure spray gun comprising an immovable securing clip with two securing parts, which are insertable into diametrically opposed lateral openings of the inlet channel in order to engage behind the insert nipple, and which are spreadable apart in a spring-elastic manner by an actuating element which is displaceably arranged in the housing.

2. High-pressure spray gun in accordance with claim 1, wherein the actuating element is displaceably held in a guide of the housing.

3. High-pressure spray gun in accordance with claim 1, wherein the actuating element forms a wedge which is insertable between the two securing parts.

4. High-pressure spray gun in accordance with claim 1, wherein the actuating element is designed as a pushbutton which blends into the outer contour of the housing.

5. High-pressure spray gun in accordance with claim 1, wherein the actuating element is held on the securing clip.

6. High-pressure spray gun in accordance with claim 1, wherein the actuating element has a clamp portion which is clamped between the securing parts.

7. High-pressure spray gun in accordance with claim 1, wherein the securing clip comprises a spring element which joins the ends of the securing parts that face away from the actuating element to each other.

8. High-pressure spray gun in accordance with claim 7, wherein the spring element is of U-shaped configuration.

9. High-pressure spray gun in accordance with claim 8, wherein the spring element comprises two legs which are aligned parallel to the longitudinal axis of the inlet channel and are integrally joined to each other by a crosspiece.

10. High-pressure spray gun in accordance with claim 7, wherein the spring element is integrally joined to the securing parts.
